(19) United States
(12) Patent Application Publication
(10) Pub. No.: US 2007/0067240 A1
(43) Pub. Date: Mar. 22, 2007

(54) Method, system, and program product for resolving unmatched payments

(76) Inventor: James Grant George, Brush Prairie, WA (US)

Correspondence Address: James Grant George, 13101 NE Glory Road, Brush Prairie, WA, 98606, US

(21) Appl. No.: 11/229,205

(22) Filed: Sep. 19, 2005

(51) Int. Cl. G06Q 40/00; G06F 17/00; G06F 7/00

(52) U.S. Cl. 705/45; 707/104.1

(57) ABSTRACT

Electronic payment processing including a data processing methodology and apparatus that facilitates resolving unmatched payments with customer accounts at a payee. This is accomplished by comparing an unmatched check or other payment received with previously resolved payments and associated customer numbers, as stored in a database. The first, and ongoing, phase of the process is to capture in a database both the unique bank account number and the customer account number for resolved payments. Thus, the database is built up over time and covers increasing numbers of unique bank account/customer number pairs. Once the database exists, the account number for each future unmatched payment may be rapidly found by comparing the subsequent unique bank account numbers to entries in the database. This unmatched payment can then be posted to the customer account number found by this match. If there is no match, the tedious traditional methods of research must be resorted to. But when this research is completed the resulting paired data is added to the database, preventing the need for traditional research efforts when future unmatched payments are received from the just-researched bank account. Thus, a customer who never returns a payment coupon will be researched in the traditional ways only once, not month-after-month.

### BACKGROUND OF THE INVENTION

### 1. Field of the Invention

This invention relates to the field of payment processing and, more specifically, to a data processing methodology and apparatus that facilitates resolving unmatched payments with customer accounts.

### DEFINITIONS OF TERMS USED

Payment—Any payment instrument, including check, image of a check, electronically transmitted check data, ACH item (Automated Clearing House) wire transfer, debit card item, credit card item, and so forth. Payments are made from the customer to the payee.

Customer—In this context, the person or organization making a payment to a payee.

Payee—Any organization or individual owed money or being paid money by their customer(s). A payee typically records customers' payments to a system of accounts.

Customer account—the specific account on the books of the payee which is used to record the payment due from and/or received from a specific customer. A customer may have more than one account, (as an example, multiple insurance policies), with a payee.

Coupon—An invoice or other slip of paper traditionally provided to the customer for that customer to enclose with a check payment (or its electronic equivalent). The coupon is used by the payee, or its agent, to identify the customer account to be credited with the payment.

Unmatched payment—A customer payment received without a coupon or electronic indication of the customer account to be credited.

Bank account number—The number of the bank account used by the customer to make the payment.

Routing Transit (RT) Number—The number used by payment clearing systems to identity the customer's bank.

Unique Account Number—the combination of the RT number and the bank account number. This combination uniquely identifies the customer's bank account in the nation's banking system. This is also referred to as the payment indicia.

### 2. Background Art

Payment processing is a major cost element for large businesses. One way of reducing the cost of payment processing is to “outsource” payment processing. Typical this is done by lockbox contractors, sometimes referred to as lockboxes. A lockbox is a preferred form of outsourced payment processing provided to businesses with high volumes of customer payments. In a lockbox scenario, the business (alternatively referred to herein as “creditor” or “payee”, which terms are used interchangeably herein) gives its customers a payment coupon or invoice to send in along with the check payment. The customer's check and the payment coupon or invoice are returned to the lockbox for processing the payment. Return of this payment coupon or invoice is to assure proper posting of the payment to the customer accounts on the payee's books.

In practice the lockbox provider opens the mail, matches the coupons or invoices to the checks, deposits the checks, and sends to the coupons to the business creditor or merchant for proper crediting of the payments to the customers' accounts on the payee's books. Alternatively, the lockbox provider may provide the business creditor or payee with a digitized list of customer-payer account numbers and payments.

In practice a problem arises because many customers either fail to return the payment coupon or obliterate the coupon. The associated payments are referred to as “unmatched” payments. They are an exception condition, and processing these unmatched payments constitutes exception processing.

Currently, either the unmatched checks, images of the unmatched checks, or data from unmatched payments are sent to the payee for manual research. The business's research group uses various systems of record to manually match the payments to customer account numbers, and credits the customer account with the payment. Currently, this can be an excessively tedious process. If that process breaks down, the customer's account could be erroneously flagged for non-payment, and even turned over for collection, even though the customer's payment was made on time and was charged against their bank account.

While the process has been described with respect to a lockbox separate and distinct from the payee, it is to be understood that this is only for purposes of illustration, and the lockbox, research, and application of payments to accounts may be different functions or departments within one enterprise.

The manual labor of researching the payments in order to assign proper customer account numbers on the payee's books motivates a way of partially automating the process.

### SUMMARY OF THE INVENTION

The invention provides a method of resolving unmatched payments by comparing an unmatched payment with previously resolved payments and associated customer numbers stored in a database.

The first, and ongoing, phase of the process is to capture in a database both the unique bank account number and the customer account number for resolved payments. Thus, the database is built up over time and cover increasing numbers of unique bank account/customer number pairs.

Once the database exists, the second phase may begin. The account number each unmatched payment may be rapidly found by comparing the subsequent unique bank account numbers to entries in the database. This unmatched payment can then be posted to the customer account number found by this match. If there is no match, the traditional methods of research must be resorted to. But when this research is completed the resulting paired data is added to the database, preventing the need for traditional research efforts when future unmatched payments are received from the just-researched bank account. Thus, a customer who never returns a payment coupon will be researched in the traditional ways only once, not month-after-month.

The method, system, and program product described herein is based on the empirical observation that many customers who send in unmatched payments had sent in payments previously which had been drawn against the same bank account. Also, it is observed that some individuals have a higher propensity to make unmatched payments, and if a customer is in habit of omitting the coupon or invoice, that customer may have made many unmatched payments, in a calendar year.

This improved research process may be performed by the payee, its lockbox provider, or another party.

### THE FIGURES

Various aspects of the invention are illustrated in the Figures appended hereto.

FIG. 1 illustrates a check with the fields, that is, the routing number, the check number, and the individual customer's checking account number, shown.

FIG. 2 illustrates a high level flow of the entities and functions involved in a lock box payment processing operation.

FIG. 3 illustrates a flow chart of the method of the invention.

### DETAILED DESCRIPTION

According to the invention described herein, we provide a method, system, and program product for resolving unmatched payments, i.e., checks or other payments unaccompanied by an invoice or payment coupon with the customer's account number.

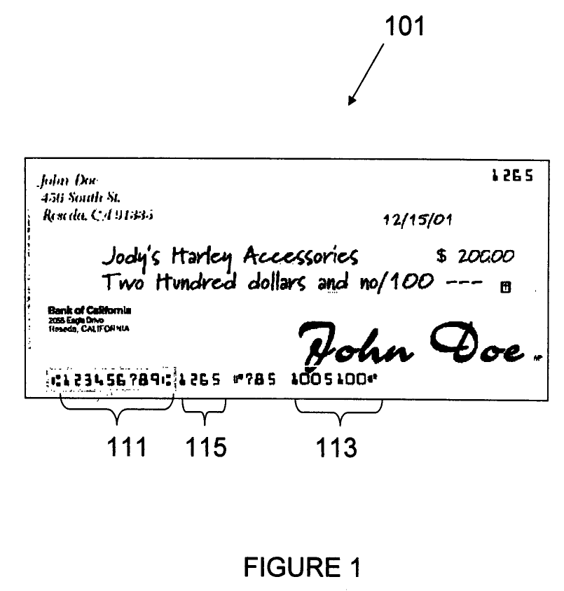

FIG. 1 illustrates a check 101 with the fields, containing, the routing number 111, the individual customer's account number 113, and the check number 115. These numbers, referred to herein as check indicia, maybe be captured by Magnetic Ink Character Recognition (MICR) or Optical Character Recognition (OCR). Moreover, the payments may be presented as paper checks or any other form of payment, as the same problem potentially exists and the solution is the same process.

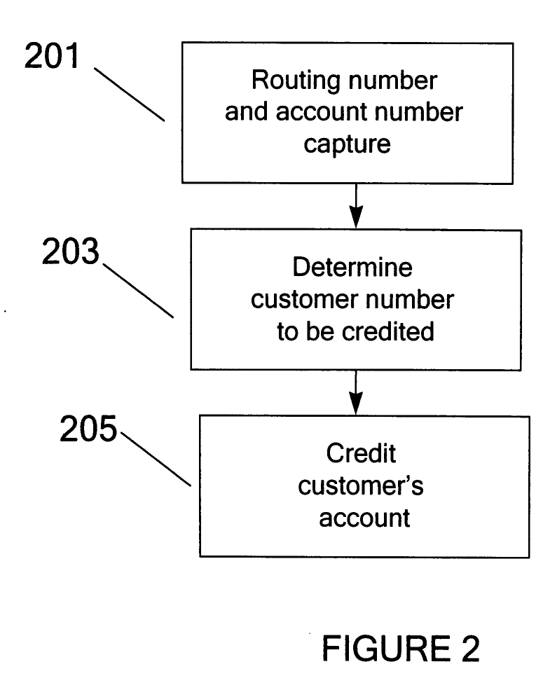

FIG. 2 illustrates a high level overview of payments processing. In the illustration, a lockbox vendor captures the check indicia, 201, including the check routing number 111 the individual customer account number 113, and, optionally, the check amount. The customer number is then determined 203. If the coupon is included it is used to determine the customer account to credit. If no coupon is enclosed, a match query is accomplished by the method, system, and program product described herein. Thereafter, the payer's account is credited on the books of the payee 205.

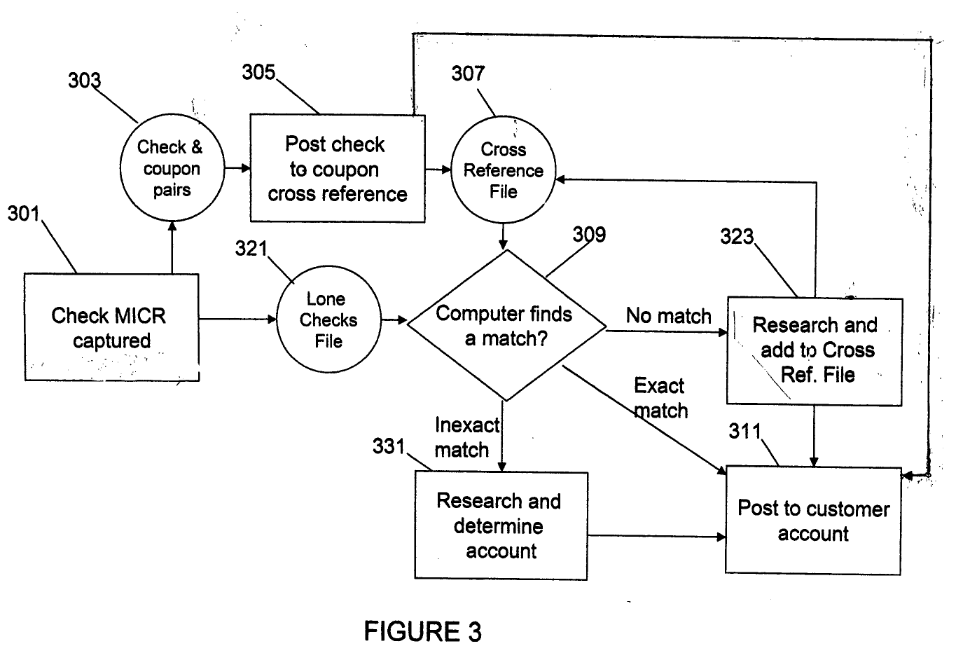

FIG. 3 illustrates the method and system of the invention.
The payments database 307 contains the associations of checking account indicia, that is, routing number and checking account number, to customer account numbers. The first step in building the payments database is capturing the check routing information and the checking account number appearing on the check 301. This information can be magnetically captured using the MICR (Magnetic Ink Character Recognition) line or optically captured using the OCR (Optical Character Recognition) line. For a matched check and payment coupon 303 the check indicia (check routing number and checking account number) are posted to the “check to coupon” cross reference database. A matched payment is credited to the customer's account 311.
When a lone check is received, that is an unmatched check, the check indicia is entered into a lone checks file 321. The “check to coupon” cross reference database is queried for a match 309. If no match is found manual research is carried out and if an exact match is found, the match added 323 to the “check to coupon” cross reference database 307 and the payment posted to the to the customer's account with the merchant 311.
If, however, if only an inexact match is found, further research is carried out, usually manually, to resolve the payment 331. An inexact match may occur if the bank account has been used as a source of payments to more than one customer account or if the customer account identified is no longer open for crediting.
As the last part of building the database, the MICR or OCR line data (bank routing number and customer checking account number), the customer account number with the check payee, and transaction amount form a single transaction. This is posted to a database with one record for each unique set of bank routing number and customer checking account number, customer account number with the check payee combination.

The payments database may be one or more separate and distinct databases associated to each of the payee 205. Alternatively, the payments database may be part of or associated with the match module and process 203. Security may be provided by one or both of encryption or access control.

Researching Unmatched Checks Using The Database. Once the payment database exists, the information on the face of an unmatched check (MICR or OCR data) from each unmatched check could be matched against the files in the database, as a query. If there is a unique match, the payment would normally be posted to the customer account on the payee merchants books associated to the customer account number.

In one type of exception condition, the information on the face of the check matches more then one entry on the database. This generally means that the customer may have more then one account with the payee. This is an exception condition.
One solution would be to automatically post the payment to an account if the amount of the check matches the amount due on one of the accounts in question.
Another solution would be to automatically post the payment to an account if the amount of the check matches the amount of one of the matching payment records on the payments database.
A third solution would be to manually research the payment.

One advantage of the invention is that even if manual research is required, the research process would be expedited and simplified because the field of inquiry would have been reduced by the database matching, with check most likely being posted to one of the accounts identified by database matching rather then to the much larger universe of thousands or hundreds of thousands or more accounts.

If the information on the face of the check does not match any entry in the database, the payment may be the first payment from this checking account, or the first payment from this customer to this payee. This exception would need to be manually researched, But the manual research may be conducted over a smaller set of accounts, that is, newly opened accounts. Only if the payment is not resolved from the set of newly opened accounts will it be necessary to research the entire set of accounts,

Once the research is completed and the payment posted, the database will be updated so that further payments with the unique account number can be performed easily from the database.

The invention may be implemented, for example, by having the system for capturing bank indicia and customer account data, and using the sets of data to match unmatched payments as software or as a program product. This is accomplished by executing the method as a software application, in a dedicated processor, or in a dedicated processor with dedicated code. The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for securing and accessing digital data as a software application. It could even be implemented using a template created on a spreadsheet program such as Excel or Lotus 1-2-3. Such a template has been created and used by the inventor as a prototype, with rows representing payments and columns for the payment's RT number, bank account number, customer account number, as required, and date and amount fields, as optional.

This signal-bearing medium may comprise, for example, memory in a server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable code, script code and wizards for installation, as in Zip code and cab code. As used herein the term machine-readable instructions or code residing in or on signal-bearing media include all of the above means of delivery.

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

I claim:

1. A method of resolving unmatched payments, comprising the steps of:
a) capturing into a payments database, routing number and checking account number, and associated customer account number with matched payments;
b) capturing into said payments database routing number and checking account number and associated customer account number from a researched payment;
c) receiving a subsequent unmatched payment and entering the routing number and checking account number therefrom into a checking account matching query and accessing said payments database; and
d) posting said subsequent unmatched payment to an account number, where said account number is found by comparing said subsequent check routing number and checking account number to said first and second check routing number-checking account number pairs in said payments database.

2. The method of claim 1 wherein the said previous matched payment was matched by research.

3. The method of claim 1 wherein the said previous matched payment was a check and accompanying payment coupon.

4. A method of resolving unmatched payments, comprising the steps of:
a) capturing into a payments database, a first check identification indicia including a check routing number and an associated checking account number from a matched payment, and a payment coupon identification indicia including a customer number on a payee's books;
b) receiving a subsequent unmatched payment and entering the check identification indicia including the check routing number and the associated checking account number therefrom into a checking-account matching query of said payments database;
c) querying said database to match said check identification indicia to payment coupon identification indicia; and
d) if said match exists associating said unmatched payment to a payee and customer account number.

5. The method of claim 4 wherein the said previous matched payment was matched by research.

6. The method of claim 4 wherein the said previous matched payment was a check and accompanying payment coupon.

7. The method of claim 4 wherein the payments database is associated to the step of matching.

8. The method of claim 4 wherein the payments database is associated to a step of associating a payment to a payee and customer account number.

9. A program product comprising a medium having computer readable instructions thereon to configure and control a system to carry out a method comprising the steps of:
a) capturing into a payments database, a first check routing number, associated checking account number, and an associated payee customer account number from a matched payment;
b) capturing into said payments database a second check routing number and associated checking account number and associated payee customer account number from a researched payment;
c) receiving a subsequent unmatched payment and entering the routing number therefrom into a check-account matching query of said payments database; and
d) posting said subsequent unmatched payment to a customer account number with a merchant payee , where said customer account number is found by comparing said subsequent check routing number and checking account number to said first and second check routing numbers in said payments database to resolve unmatched payments.

10. The program product of claim 9 wherein the said previous matched payment was matched by research.

11. The program product of claim 9 wherein the said previous matched payment was a check and accompanying payment coupon.

12. The program product of claim 9 wherein the payments database is associated to the step of matching.

13. The program product of claim 9 wherein the payments database is associated to a step of associating a payment to a payee and customer account number.

14. A computer system comprising a check and payment coupon capture module, a match query module, and an account crediting module, said system adapted and configured to:
a) capture check indicia in the check and payment coupon capture module;
b) match unmatched checks to customer accounts on a merchant database; and
c) credit matched payments to customer accounts on the merchant database;
said system carrying out the process of:
a) in the check and coupon capture module, capturing into a payments database associated to the match query module, a first check routing number, associated checking account number, and an associated payee customer account number from a matched payment;
b) capturing into said payments database associated to the match query module a second check routing number and associated checking account number and associated payee customer account number from a researched payment;
c) in the check and coupon capture module, receiving a subsequent unmatched payment and entering the routing number therefrom into a checking account matching query of said payments database associated to the match query module; and
d) posting said subsequent unmatched payment to a customer account number with a merchant payee on the merchant database, where said customer account number is found by comparing said subsequent check routing number and checking account number to said first and second check routing numbers in said payments database associated to the match query module to resolve unmatched payments.

15. The computer system of claim 14 wherein the said previous matched payment was matched by research.

16. The computer system of claim 14 wherein the said previous matched payment was a check and accompanying payment coupon.

17. The computer system of claim 14 wherein the payments database is associated to the matching module.

18. The computer system of claim 14 wherein the payments database is associated to the account crediting module.
